(19) United States
(12) Patent Application Publication
(10) Pub. No.: US 2009/0165372 A1
(43) Pub. Date: Jul. 2, 2009

(54) Garden edging

(76) Inventor: Peter Smart, Queensland (AU)

Correspondence Address: Martin P. Hoffman;HOFFMAN, WASSON & GITLER, P.C., 2461 South Clark Street, Suite 522, Arlington, VA, 22202, US

(21) Appl. No.: 12/003,414

(22) Filed: Dec. 26, 2007

(51) Int. Cl. A01G 1/08

(52) U.S. Cl. 47/33

(57) ABSTRACT

Flexible lengths of garden edging made from recycled rubber can be placed on the ground and pinned thereto. By being flexible, the garden edging will not crack or break when stood on and therefore can have a fairly slimline forward edge which makes mowing easier.

### FIELD OF THE INVENTION

The present invention is directed to garden edging and particularly directed to garden edging which is made of flexible material and which has a particular design to enable the edging to be placed in position and attached to each other.

### BACKGROUND OF THE INVENTION

Garden edging is well known and is used to separate a lawn from a garden bed. The garden edging can be made from concrete, wood, plastic and the like.

One difficulty with garden edging is that an abrupt edge presents difficulties in mowing right up to the edge of the garden edging. For this reason, it is known to provide L-shaped garden edging comprising a vertical portion which sits against the garden bed, and a horizontal portion. This allows a mower to get much closer to the garden edging. While this type of product is very popular, there are still some difficulties. Firstly, if the garden edging is made of concrete, the horizontal portion has to be quite thick to stop the concrete from breaking. However, the thicker that the horizontal portion is, the more difficult it is to mow right up against the horizontal portion. For this reason, concrete garden edging is normally sunk into the ground such that the thick horizontal portion can still present a substantially flush surface with the grass. This however raises another problem which is that once the garden edging is in place, it cannot be moved. There are many instances, where it is desired to move the garden edging.

Making concrete garden edging thinner is not a practical solution as the edging can easily crack, break, etc. A similar problem exists with wooden garden edging or garden edging made of relatively rigid material such as rigid plastics, etc.

Portable garden edging is also known. The edging typically comprises a vertical member that can be pinned together usually by a backing wire. The edging can be sold in a roll and then unrolled and curved to shape. Usually, this type of garden edging does not present a horizontal surface which makes mowing easier.

Garden edging made from recycled material is known. The recycled material can comprise recycled plastic, recycled rubber, etc. The edging typically comprises lengths which can be placed next to each other.

It is generally found that garden edging made from recycled material is fairly stiff (rigid) and therefore not reasonably flexible. If such garden edging is L-shaped to provide the advantageous horizontal portion, it is found that the garden edging is not very flexible or not flexible at all.

Another disadvantage generally with garden edging of the type that is L-shaped is that the ground on which it will be used is not often level or of uniform hardness. Thus, if the garden edging is simply placed on top of the ground, and if a person stands on the garden edging, the garden edging can break, crack, split, etc. For instance, the ground may contain pockets or undulations or the ground may have some areas which are relatively hard and some areas which are soft. For this reason, most garden edging is still somewhat dug into the ground. This then makes it more difficult to move the garden edging or to reshape the garden edging.

Another disadvantage generally of garden edging is that it is difficult and fiddly to join adjacent lengths of garden edging together. Mostly, adjacent lengths are simply placed next to each other and are not joined. However, this can result in unsightly separation or misalignment over time.

Therefore, there would be an advantage if it were possible to provide garden edging of the type that does not need to be dug into the ground (e.g. can be placed on the surface), and which has a configuration that allows mowing to be done more efficiently right up against the garden edging, and where the edging is also somewhat flexible such that it can be curved or moved to decorative shapes or can follow the ground surface when stood on (thereby preventing cracking) and where it can also be possible to readily attach adjacent lengths of garden edging together.

It will be clearly understood that, if a prior art publication is referred to herein, this reference does not constitute an admission that the publication forms part of the common general knowledge in the art in Australia or in any other country.

### BRIEF SUMMARY OF THE INVENTION

It is an object of the invention to provide garden edging that may overcome at least some of the above-mentioned disadvantages or provide the consumer with a useful or commercial choice.

In a broad form, the invention resides in garden edging which comprises at least one elongate member which can be placed on the ground, the elongate member being made of resilient material and having a bottom wall adapted to be placed on the ground, and a forward edge adapted to face the lawn, the forward edge having an inclined upper surface.

In a more particular form, the invention resides in garden edging, the edging comprising an elongate member, the elongate member having an upright portion which is usually against the garden bed, and a horizontal portion, the garden edging able to be simply placed on the ground and not required to be dug into the ground, the garden edging being made of resilient material, at least one fixing means in the garden edging to enable the garden edging to be fixed to the ground.

The garden edging may be made of recycled material such as recycled rubber crumb, other types of recycled rubbers, but it is envisaged that the garden edging may also be made of virgin rubber. Other types of material that impart a resilient nature to the garden edging may be used. These materials may include synthetic rubbers (e.g. neoprene), silicones, homopolymers and copolymers, including nitrites, dienes, butadienes, ABS rubbers, cross-linked polymers and the like.

It is envisaged that the garden edging will be made of such materials bonded together. The bonding will usually comprise an adhesive. The adhesive may comprise a polyurethane adhesive, although the invention should not be limited to any particular type of adhesive, and there is available commercial adhesives which are used to bond rubber crumb. It is considered that a person skilled in the art would be able to determine the type and amount of adhesive which will be suitable.

The elongate member will typically have a length of between 0.5 m up to 3 m, and a more preferred length of between 0.5 m up to 1.5 m, although circumstances may exist where the elongate member may be shorter or longer.

The elongate member may be straight, curved, or have complex configurations but the elongate member should be resilient such that whatever shape it initially has, it can be reshaped if desired.

The elongate member will typically have an upright portion and a horizontal portion. It is envisaged that the elongate member will be somewhat L-shaped in section. The upright portion and the horizontal portion may have a length similar or dissimilar to each other. The upright portion may have a length of between 10-20 cm and the horizontal portion may also have a length of between 10-20 cm, although it is not envisaged that the invention should be limited to these dimensions.

It is also envisaged that the horizontal portion will extend substantially at right angles to the upright portion, although this need not be essential and the horizontal portion may be at other angles relative to the upright portion if desired.

The upright portion may comprise a continuous or discontinuous wall. For instance, the upright portion may comprise a number of subportions that are separated from each other, although it is envisaged that in most instances, the upright portion will comprise a continuous wall.

Similarly, the horizontal portion may comprise a continuous or discontinuous wall for the reasons given immediately above, although it is again envisaged that in most instances, the horizontal portion will comprise a continuous wall.

By being made of resilient material, or primarily of resilient material, the garden edging can be placed on the ground and does not need to be dug into the ground. However, circumstances may arise where there is an advantage in somewhat recessing the edging in the ground.

While it is preferred that the garden edging is made substantially or even entirely of resilient material, there may be circumstances where part of the garden edging are rigid. For instance, the garden edging may contain some rigid reinforcing in certain areas where the resilience or flexibility advantages are not required.

The garden edging contains at least one fixing means to enable it to be fixed to the ground. The fixing means may be positioned on a horizontal portion of the garden edging and/or on a vertical portion. The fixing means may comprise at least one opening which can extend through the garden edging and through which a fastener such as a pin or stake can pass to pin the garden edging to the ground or to something else.

Typically, a number of openings will be provided through which a number of pins can pass. Thus, it is possible to pin the garden edging to the ground (for example) at various places and this can be an advantage especially if the garden edging is bent around a corner, etc. and there is an advantage in using a number of pins in this area to prevent the garden edging from returning to its original shape.

The pins may comprise steel pins, plastic pins, wooden pins, and the term “pins” is meant to include any elongate member that can be used as an anchor such as a nail, a rod, a stake and the like. The pins may have different sizes and it is envisaged that the pin will have a length of between 10-30 cm and a diameter of thickness of between 3-5 mm although this can vary to suit.

The garden edging may comprise attachment means to enable adjacent garden edging members to be connected to each other.

In one form, the attachment means comprises an extending member extending from one garden edging against which an adjacent garden edging can be attached.

The extending member will typically extend from one end edge of the garden edging. The extending member may comprise a bracket, a ledge, a rib, a flap, or any other type of member against which an adjacent garden member can be attached.

Typically, a fastener such as a screw, a nail, a pin, and the like can be used to lock the two members together. Therefore, it is envisaged that the attachment means will comprise at least one opening through which the fastener can pass. However, it is also envisaged that the fastener may comprise a clamp, some form of release adhesive and the like.

It is preferred that the attachment means extends at least partially along the upright portion of the garden edging and/or at least partially along the horizontal portion of the garden edging.

### BRIEF DESCRIPTION OF THE DRAWINGS

Embodiments of the invention will be described with reference to the following drawings in which:

FIG. 1. Illustrates an upper view of an elongate member comprising a garden edge.

FIG. 2. Illustrates a section view of the garden edging of FIG. 1.

FIG. 3. Illustrates a second embodiment of the invention intersection view and where the garden edging is substantially L-shaped.

FIG. 4. Illustrates a perspective view of the garden edging of FIG. 3.

FIG. 5. Illustrates a close-up view of one edge of the garden edging showing a preferred attachment means.

FIG. 6. Illustrates a below view of the garden edging of FIG. 5.

FIG. 7. Illustrates a third embodiment of the invention.

FIG. 8. Illustrates a single elongate member which forms part of the third embodiment.

FIG. 9. Illustrates a section view of the garden edging according to a third embodiment of the invention.

FIG. 10. Illustrates the version of the invention generally as illustrated in FIG. 5, but with a slightly different attachment mechanism.

### DETAILED DESCRIPTION

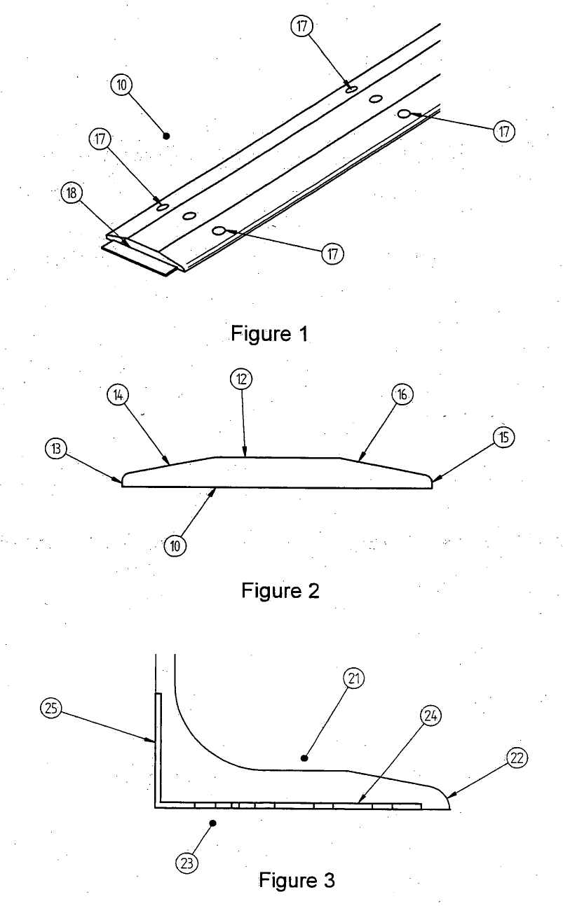

Referring to the illustrations and initially to FIGS. 1-2, there is shown the first embodiment of the invention which is also the simplest embodiment. In this embodiment, there is provided garden edging which comprises at least one elongate member 10. In the particular embodiment, and also best illustrated in FIG. 2, elongate member 10 has a bottom wall 11 which, in use, can sit on the ground or grass, a top wall 12 which, in the particular embodiment, is relatively flat, a front edge 13 which faces the grass and which has an inclined upper wall 14 which extends from the front edge 13 and to top wall 12. In the particular embodiment, there is also a rear edge 15 which also has an inclined upper wall 16 which means that the elongate member is symmetrical. The top wall is provided with attachment means which, in the particular embodiment, comprises openings 17 through which a steel pin (not illustrated) can pass to pin the elongate member to the ground.

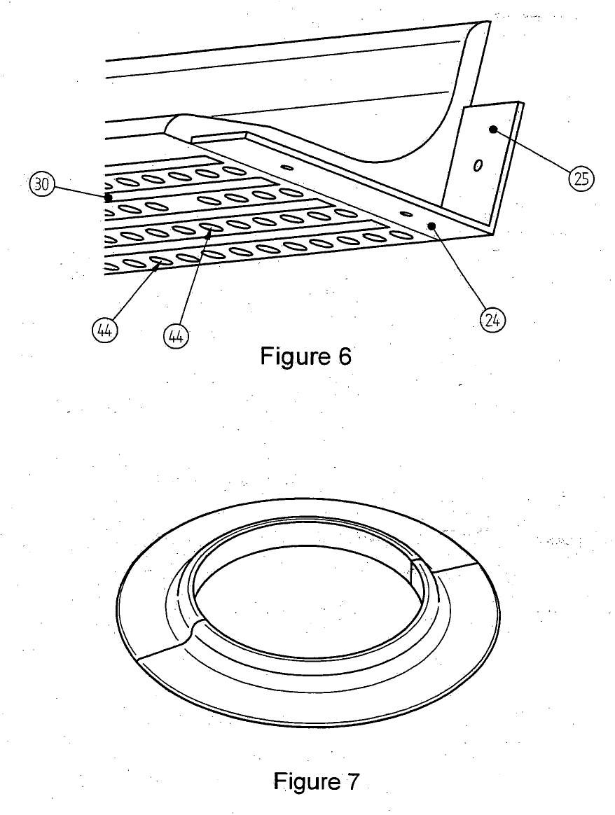

The elongate member has one end edge 18 which contains a bracket or similar to enable adjacent members to be attached together. This bracket will be described in greater detail with respect to the second embodiment and particularly FIGS. 5-6. While the bracket in the second embodiment is described as an L-shaped bracket, it should be appreciated that the bracket in the first embodiment of the invention illustrated in FIGS. 1-2 will be substantially flat.

The elongate member will typically have a length of about 1 m, the bottom wall 11 has a width of 200 mm, the top wall has a width of 80 mm, and each inclined wall has a width of 60 mm. Of course, no particular limitation should be placed on the invention by illustrating these particular sizes.

Importantly, the inclined edges 13, 15 can be made relatively thin, and in the particular embodiment, the inclined edge has a forward most portion of about 10 mm and a thickest portion (where it contacts top wall 12) of about 20 mm. This enables a mower to mow very close to the edge.

This is achieved by making the garden edging out of resilient material. In the embodiment, the resilient material may comprise re-bonded rubber which comprises rubber crumb in a settable adhesive. If desired, the garden edging may be covered with a nonslip rubber compound which provides an attractive “skin”. Both these products are known in the art.

The product as illustrated in FIGS. 1-2 will find particular use underneath fence panels.

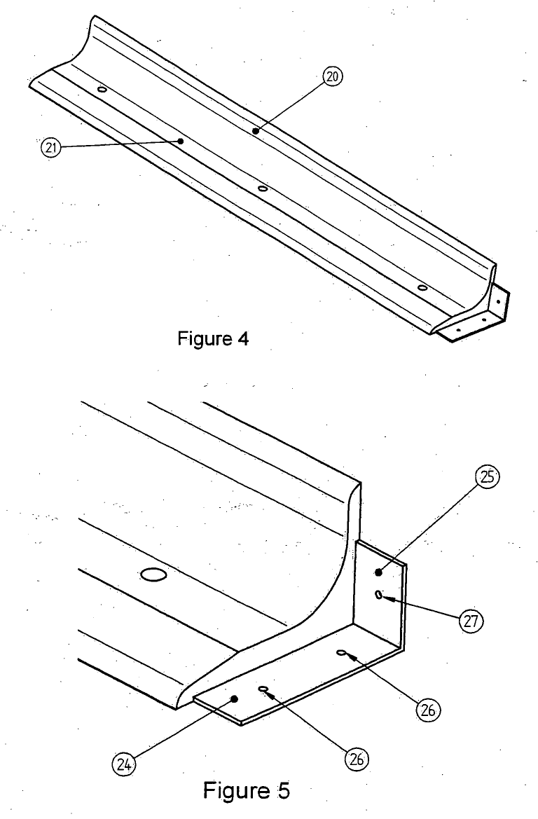

Referring to the second embodiment of the invention illustrated in FIGS. 3-6, there is illustrated an L-shaped garden edging. The L-shaped garden edging has an upright (typically vertical) wall 20 and a substantially horizontal wall 21. Upright wall 20 has a height of about 100 mm, while horizontal wall 21 has a width of about 150 mm. The edging can have a length of about 1 m. Again, no particular limitation should be placed on the invention nearly by illustrating these precise sizes.

The garden edging according to the second embodiment of the invention can also be made of resilient recycled rubber crumb as described with reference to the first embodiment. Therefore, the garden edging is somewhat flexible and can be bent or curved into different positions. Also, the material enables the front edge 22 to again be made relatively thin and because the edge is flexible, the edge will not crack, break, split, etc.

The garden edging can be pinned to the ground and attached to adjacent garden edging using a clever bracket system. The bracket system is best illustrated in FIGS. 3, 5 and 6 and, in the particular embodiment, comprises an L-shaped bracket 23 having a horizontal flange portion 24 and a vertical flange portion 25. The horizontal portion 24 does not extend entirely to the front edge 22 but is spaced inwardly by a few millimetres. The horizontal portion contains openings 26 through which pins can pass to pin the garden edging to the ground in a concealed manner. The vertical flange portion 25 also contains openings 27. Typically, the garden edging will have one end edge and an opposite edge formed with the particular bracket. This enables the end edge of an adjacent garden edging to be placed on the “bracket end” of the first garden edging, and the edgings can be joined together using fasteners such as screws or pins which can also pass through openings 26, 27. However, the invention may also extend to the provision of other openings in the length of the garden edging (these openings not illustrated) through which pins can pass to pin the garden edging to the ground.

In order to provide greater flexibility to the garden edging, the garden edging may be grooved 30 which is illustrated in FIG. 6.

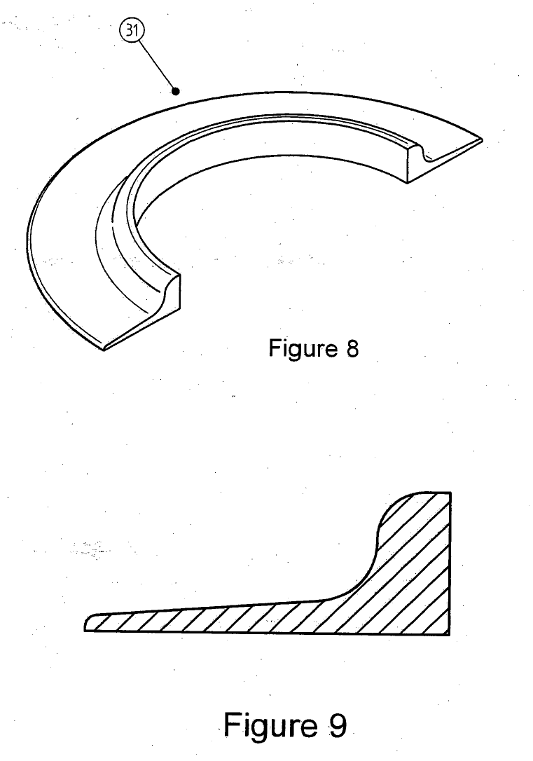

FIG. 7-9 illustrates a third embodiment of the invention. In this embodiment, the garden edging 31 (see FIG. 8) is formed in a curved configuration and again comprises an L-shaped section (see FIG. 9). As illustrated in FIG. 7, two of these edgings 31 can be placed together and attached to form a neat circle.

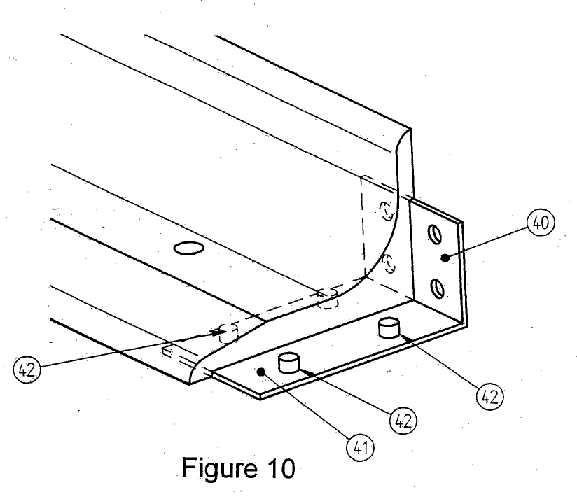

FIG. 10 illustrates a version of the invention which is similar to that illustrated in FIG. 5, except that the attachment means comprises a separate L-shaped bracket member which is formed separately from the garden edging. The L-shaped bracket member will typically be made of sheet metal/plastic/rubber etc. The bracket member has an upright wall 40 that extends behind the garden edging, and a horizontal wall 41 that sits underneath the garden edging. The horizontal wall 41 is wide enough such that an edge of each adjacent guarding edging can sit on top of the horizontal wall. The horizontal wall contains upright cylindrical studs 42. or other types of pins or attachment means which pass within openings (not illustrated) formed in the garden edging such that adjacent lengths of garden edging can be easily attached together using the bracket member. An advantage of this is that the garden edging can be cut to any length and it is not necessary to provide garden edging with “in situ” attachment means.

Referring again to FIG. 6, it can be seen that the underside of the garden edging is provided with an array of openings (typically closed at the inner end). These openings enable the garden edging to be cut to any suitable length and then fastened to another garden edging using the L-shaped bracket described above. FIG. 6 illustrates representative openings only, and it is expected there will be arrays of such openings.

It can also be understood that it is possible to insert a straight garden edging between the curved edgings to provide an elongate oval shape. Thus, it is also possible to provide various complex shapes, curves and profiles using the various different types of garden edging. As each garden edging is also resilient, it can also be moved and shaped and pinned into place.

By being made of recycled rubber crumb, the garden edging will not crack or split when walked on and especially if laid on soft or undulating ground. Thus, it is not necessary to dig the garden edging into the ground. A lawnmower can pass very close to the garden edging due to its “slimline” front edge design, this being possible because of the rubber manufacture. A lawnmower can also move on to the garden edging with little or no damage to the edging. A line trimmer can be used with little or no damage to the line as the garden edging is resilient. The garden edging can be easily pinned into place, easily attached to each other, and also easily removed when not required. The garden edging is versatile, reusable and long-lasting with the benefit of using recycled material. The garden edging can be made available in different colours and with different textures. It is envisaged that the garden edging will be made by moulding the rubber in steel mould casings. A person can easily handle the product due to its weight and length. The edging is not permanently fixed or dug into the ground.

Throughout the specification and the claims (if present), unless the context requires otherwise, the term “comprise”, or variations such as “comprises” or “comprising”, will be understood to apply the inclusion of the stated integer or group of integers but not the exclusion of any other integer or group of integers.

Throughout the specification and claims (if present), unless the context requires otherwise, the term “substantially” or “about” will be understood to not be limited to the value for the range qualified by the terms.

It should be appreciated that various other changes and modifications can be made to any embodiment described without departing from the spirit and scope of the invention.

1. Garden edging comprising at least one elongate member which is made from recycled rubber in a settable adhesive and having a pair of opposed end edges, the elongate member having a planar bottom wall adapted to sit on the ground, a front edge which has an inclined upper wall, and at least one attachment member for attaching the garden edging to the ground, the at least one attachment member including at least one opening through which a fastener can pass to fasten the member to the ground, and at least one of the opposed end edges of the elongate member having a rebate adjacent the end edge adapted to at least partially receive an attachment member to attach the elongate member to the attachment member such that the bottom wall of the elongate member remains on the ground.

2. The garden edging as claimed in claim 1, comprising an elongate member having a length of between 0.5-2 m.

3. The garden edging as claimed in claim 1, comprising a substantially horizontal top wall having a width which is less than the width of the bottom wall, and an inclined wall extending from the top wall and to the front edge and rear edge of the garden edging.

4. The garden edging as claimed in claim 1, wherein the edging has a pair of opposed end edges, at least one end edge containing means to enable the garden edging to be attached to an adjacent garden edging.

5. The garden edging as claimed in claim 4, wherein said means to enable the garden edging to be attached to an adjacent garden edging comprises an elongate flange extending outwardly from the end edge and substantially in line with the bottom wall.

6. The garden edging as claimed in claim 1, which is substantially L-shaped when viewed in section and comprises a rear upright wall and a front horizontal wall.

7. The garden edging as claimed in claim 4, wherein said means to enable the garden edging to be attached to an adjacent garden edging comprises an L-shaped flange extending outwardly from one end edge of the rear upright wall and from one end edge of the front horizontal wall.

8. The garden edging as claimed in claim 7, wherein the L-shaped flange contains at least one opening through which a pin can pass to pin the garden edging to the ground and/or attach the garden edging to an adjacent garden edging.

9. The garden edging as claimed in claim 7, wherein the flange is formed separately from the garden edging and can be attached to the garden edging to enable adjacent garden edgings to be attached next to each other via the flange.

10. The garden edging as claimed in claim 9, wherein the flange contains at least one upstanding pin or stud, and the bottom wall of the garden edging contains corresponding passageways to enable the garden edging to be attached to the flange by passing the upstanding pins or studs into the passageways.

11. The garden edging as claimed in claim 6 which is curved.

12. Garden edging which comprises at least one elongate member having a pair of opposed end edges which can be placed on the ground, the elongate member being made of resilient material and having a bottom wall adapted to be placed on the ground, and a forward edge adapted to face the lawn, the forward edge having an inclined upper surface and at least one attachment member for attaching the garden edging to the ground, the at least one attachment member including at least one opening through which a fastener can pass to fasten the member to the ground, and at least one of the opposed end edges of the elongate member having a rebate adjacent the end edge adapted to at least partially receive an attachment member to attach the elongate member to the attachment member such that the bottom wall of the elongate member remains on the ground.

13. Garden edging according to claim 12, wherein said at least one attachment member is separate from the elongate member and attached a pair of adjacent elongate members relative to one another.

14. Garden edging according to claim 12, wherein said elongate member has an integrally formed attachment member extending outwardly from a first end edge and substantially in line with the bottom wall and a corresponding rebate at the other end edge.
